(19) United States
(12) Patent Application Publication
(10) Pub. No.: US 2002/0127354 A1
(43) Pub. Date: Sep. 12, 2002

(54) Liquid crystal display

(75) Inventors: Setsuo Kobayashi, Mobara (JP); Hidehiro Sonoda, Mobara (JP); Noboru Kunimatsu, Mobara (JP)

Correspondence Address: Stanley P. Fisher, Reed Smith LLP, Suite 1400, 3110 Fairview Park Drive, Falls Church, VA, 22042-4503, US

(73) Assignee: Hitachi, Ltd.

(21) Appl. No.: 10/091,215

(22) Filed: Mar. 5, 2002

(30) Foreign Application Priority Data
Mar. 6, 2001 (JP) 2001-061571

(51) Int. Cl. C09K 19/00

(52) U.S. Cl. 428/1.21

(57) ABSTRACT

A liquid crystal display device which is constructed to restrain the occurrence of ionic image retention includes substrates disposed in opposition to each other with a liquid crystal being interposed therebetween, a pixel electrode formed in each pixel area on a liquid-crystal-side surface of one of the substrates, a counter electrode which generates an electric field between itself and the pixel electrode, and alignment films disposed in contact with the liquid crystal on the liquid-crystal-side surfaces of the respective substrates. The liquid crystal has a positive or negative dielectric anisotropy, and each of the alignment films is made of a material containing a diamine structure which traps ionic impurities.

### BACKGROUND OF THE INVENTION

1. Field of the Invention

The present invention relates to a liquid crystal display device, and more particularly to an improvement in the alignment film of the liquid crystal display device.

2. Background Art

For example, an active matrix type of liquid crystal display device includes pixel areas provided on a liquid-crystal-side surface of either one of transparent substrates disposed in opposition to each other with a liquid crystal interposed therebetween, each of the pixel areas being an area surrounded by gate signal lines disposed to be extended in the x direction and to be juxtaposed in the y direction and drain signal lines disposed to be extended in the y direction and to be juxtaposed in the x direction.

Each of the pixel areas includes a switching element to be driven by a gate signal from a gate signal line disposed on one side of the pixel area, and a pixel electrode to be supplied with a video signal via the switching element from a drain signal line disposed on another side of the pixel area, and the pixel electrode is arranged to generate an electric field across the liquid crystal between the pixel electrode and a counter electrode.

One type of liquid crystal display device is known in which its counter electrodes are formed on its transparent substrate on which its pixel electrodes are formed, so that the optical transmissivity of its liquid crystal is controlled by electric fields generated between the counter electrodes and the pixel electrodes (this mode is called in-Plane-Switching Mode). This type of liquid crystal display device serves the advantage of enabling a user to observe an image through a wide viewing angle relative to its liquid crystal display surface.

In addition, another type of liquid crystal display device is known in which either one of its pixel electrode and its counter electrode is formed in a layer underlying an insulating film and is formed of a transparent conductive layer, while the other is formed in a layer overlying the insulating film and is formed of an electrode having a pattern formed to be superposed on the one and to be extended in one direction and juxtaposed in a direction transverse to the one direction. This type of liquid crystal display device serves the advantage that the aperture ratio of its pixels can be improved.

However, the liquid crystal display device constructed in this manner has the problem that electric charges remain near the electrodes and image retention easily occurs.

The existence of the remaining electric charges is considered to be due to various causes, and there is a phenomenon which is called ionic image retention. In the ionic image retention, when a liquid crystal display device is driven, ion components (organic ions, inorganic ions) that exist in its liquid crystal locally bias electric charges, and this fact becomes the cause of image retention.

In such ionic image retention, for example when a black-and-white pattern is displayed on the liquid crystal display surface for several minutes, image persistence occurs and causes the phenomenon that even if the image is switched to another image, the previous image remains.

### SUMMARY OF THE INVENTION

The invention has been made in view of the above-described problem, and provides a liquid crystal display device in which the occurrence of ionic image retention can be restrained.

The outline of a representative aspect of the invention disclosed herein will be described below in brief.

A liquid crystal display device according to the invention includes, for example, substrates disposed in opposition to each other with a liquid crystal being interposed therebetween, a pixel electrode formed in each pixel area on a liquid-crystal-side surface of one of the substrates, a counter electrode which generates an electric field between itself and the pixel electrode, and alignment films disposed in contact with the liquid crystal on the liquid-crystal-side surfaces of the respective substrates. The liquid crystal has a positive or negative dielectric anisotropy, and each of the alignment films is made of a material containing a diamine structure which traps ionic impurities.

In the liquid crystal display device constructed in this manner, it has been confirmed that the alignment films have the nature of absorbing (trapping) ionic impurities, whereby it is possible to greatly restrain the occurrence of image retention due to the ionic impurities.

### BRIEF DESCRIPTION OF THE DRAWINGS

FIG. 1 is a cross-sectional view of one embodiment of a liquid crystal display device according to the invention and shows a cross-sectional view taken along line I-I of FIG. 3;

FIG. 2 is a view showing the equivalent circuit of the embodiment of the liquid crystal display device according to the invention;

FIG. 3 is a plan view showing one embodiment of a pixel of the liquid crystal display device according to the invention;

FIG. 4 is a cross-sectional view taken along line IV-IV of FIG. 3;

FIG. 5 is a cross-sectional view taken along line V-V of FIG. 3; and

FIG. 6 is an explanatory view showing the manner of concentration of electric fields near an electrode, which causes image retention.

### DETAILED DESCRIPTION OF THE INVENTION

An embodiment of a liquid crystal display device according to the invention will be described below with reference to the accompanying drawings.

Equivalent Circuit

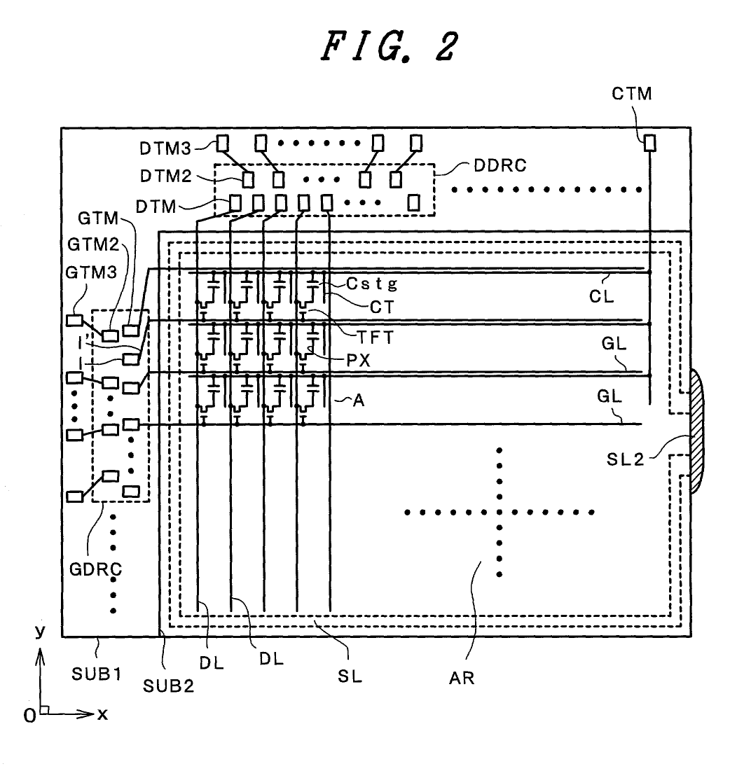

FIG. 2 is an equivalent circuit diagram showing one embodiment of a liquid crystal display device according to the invention. FIG. 2 is a circuit diagram which is depicted in accordance with the actual geometrical layout of the liquid crystal display device.

In FIG. 2, there is shown a transparent substrate SUB1. This transparent substrate SUB1 is disposed in opposition to another transparent substrate SUB2 with a liquid crystal interposed therebetween.

Formed on a liquid-crystal-side surface of the transparent substrate SUB1 are gate signal lines GL which are disposed to be extended in the x direction and to be juxtaposed in the y direction as viewed in FIG. 2 and drain signal lines DL which are insulated from the gate signal lines GL and are disposed to be extended in the y direction and to be juxtaposed in the x direction as viewed in FIG. 2. Rectangular areas each of which is surrounded by adjacent ones of the gate signal lines GL and adjacent ones of the drain signal lines DL constitute pixel areas, respectively, and a display part AR is formed by an aggregation of these pixel areas.

Formed in each of the pixel areas are a thin film transistor TFT to be driven by the supply of a scanning signal (voltage) from one of the adjacent gate signal lines GL, and a pixel electrode PX to which a video signal (voltage) is to be supplied from one of the adjacent drain signal lines DL via the thin film transistor TFT.

A capacitance element Cstg is formed between the pixel electrode PX and the other of the adjacent gate signal lines GL so that when the thin film transistor TFT is turned off, a video signal supplied to the pixel electrode PX is stored for a long time by the capacitance element Cstg.

The pixel electrode PX in each of the pixel areas is arranged to generate electric fields between the pixel electrode PX and a counter electrode CT formed on the transparent substrate SUB1, and the optical transmissivity of the liquid crystal between the pixel electrode PX and the counter electrode CT is controlled by the ones of those electric fields that have components approximately parallel to the transparent substrate SUB1.

The counter electrodes CT formed in each group of pixel areas disposed to be juxtaposed in the x direction are connected in common to one another by a respective one of the counter voltage signal lines CL, and the counter voltage signal line CL for each of the groups of the pixel areas is supplied with a reference signal which serves as a reference for a video signal to be supplied from a terminal CTM.

One end of each of the gate signal lines GL is formed to be extended to one side (in FIG. 2, the left-hand side) of the transparent substrate SUB1, and the extended portion is formed as a terminal part GTM which is connected to bumps of a semiconductor integrated circuit GDRC made of a vertical scanning circuit mounted on the transparent substrate SUB1. In addition, one end of each of the drain signal lines DL is formed to be extended to one side (in FIG. 2, the top side) of the transparent substrate SUB1, and the extended portion is formed as a terminal part DTM which is connected to bumps of a semiconductor integrated circuit DDRC made of a video signal driver circuit mounted on the transparent substrate SUB1.

The semiconductor integrated circuits GDRC and DDRC in themselves are completely mounted on the transparent substrate SUB1 by a technique which is called COG (chip on glass).

The input-side bumps of each of the semiconductor integrated circuits GDRC and DDRC are respectively connected to terminal parts GTM2 and DTM2 formed on the transparent substrate SUB1. These terminal parts GTM2 and DTM2 are respectively connected via individual interconnection layers to terminal parts GTM3 and DTM3 which are disposed in the peripheral portions of the transparent substrate SUB1 that are respectively closest to different side edges of the transparent substrate SUB1.

The transparent substrate SUB2 is disposed in opposition to the transparent substrate SUB1 in such a manner as to avoid an area in which the semiconductor integrated circuits DDRC and GDRC are mounted, and the area of the transparent substrate SUB2 is smaller than that of the transparent substrate SUB1.

The transparent substrate SUB2 is secured to the transparent substrate SUB1 by a sealing material SL formed in the periphery of the transparent substrate SUB2, and this sealing material SL also has the function of sealing the liquid crystal between the transparent substrates SUB1 and SUB2.

Incidentally, the above description has referred to a liquid crystal display device of the type which uses a COG method, but the invention can also be applied to a liquid crystal display device of the type which uses a TCP method. The TCP method is to form a semiconductor integrated circuit by a tape carrier method, and the output terminals of the semiconductor integrated circuit are respectively connected to terminal parts formed on the transparent substrate SUB1, while the input terminals of the semiconductor integrated circuit are respectively connected to terminal parts on a printed circuit board which is disposed close to the transparent substrate SUB1.

Construction of Pixel

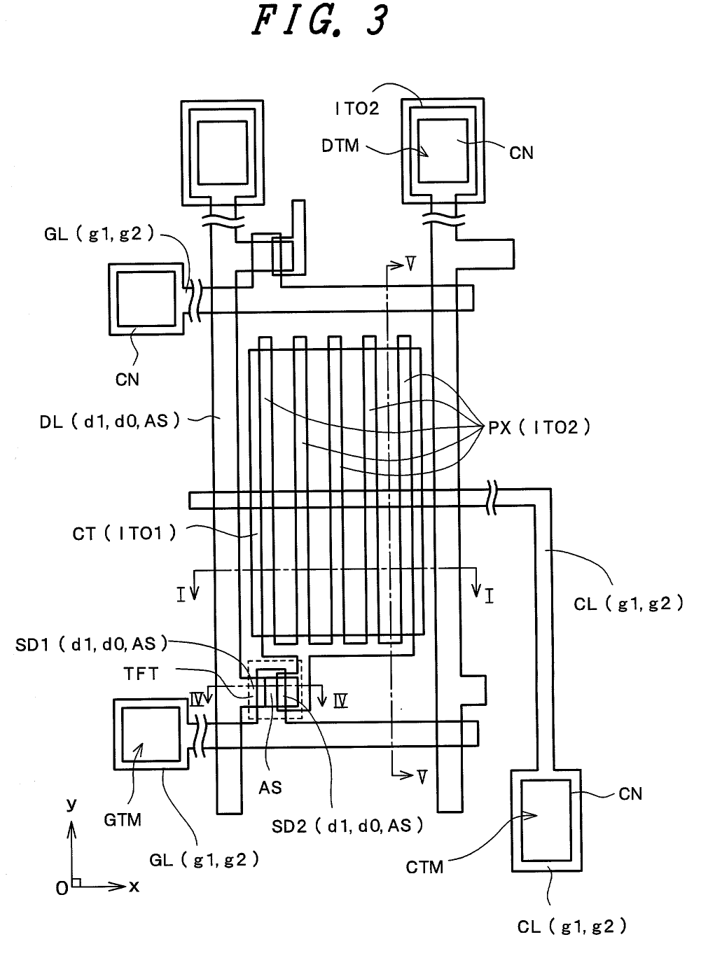

FIG. 3 is a plan view showing one pixel are surrounded by a pair of adjacent ones of the gate signal lines GL and a pair of adjacent ones of the drain signal lines DL, and also shows the terminal parts GTM connected to the respective gate signal lines GL and the terminal parts DTM connected to the respective drain signal lines DL.

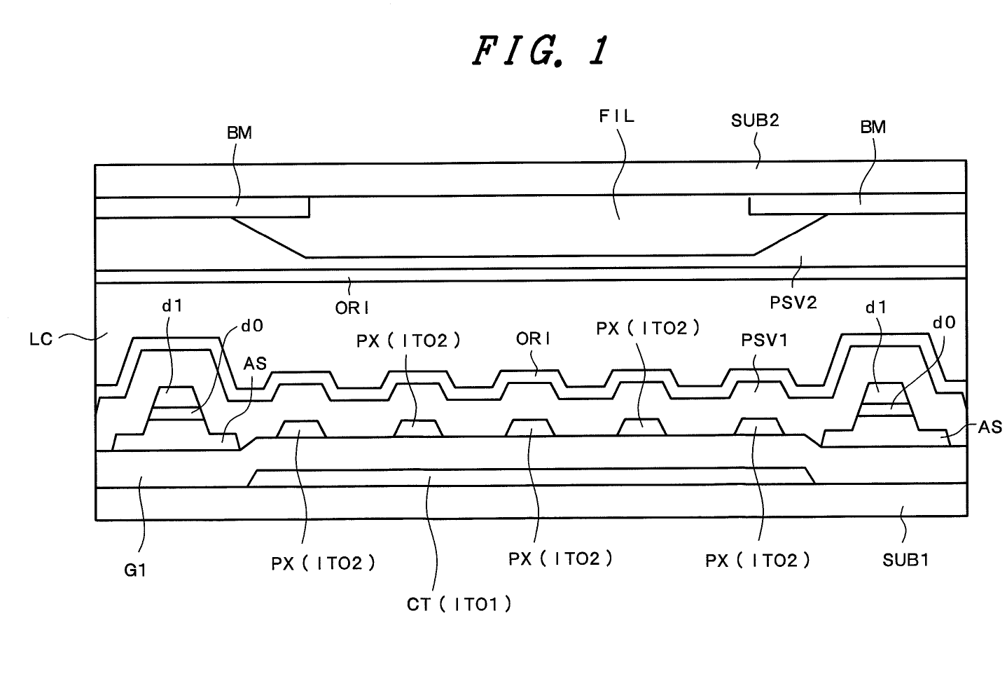

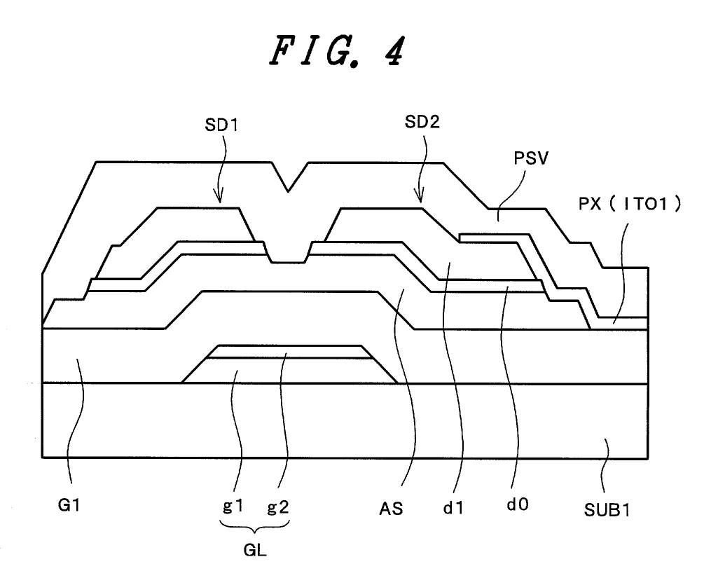

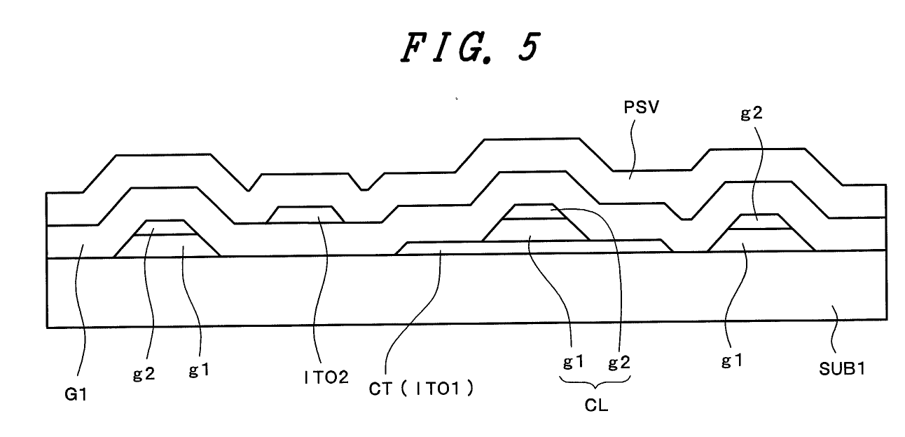

FIG. 1 shows a cross-sectional view taken alone line I-I of FIG. 3, FIG. 4 shows a cross-sectional view taken along line IV-IV of FIG. 3, and FIG. 5 shows a cross-sectional view taken along line V-V of FIG. 3.

Referring first to FIG. 3, the gate signal lines GL disposed to be extended in the x direction and to be juxtaposed in the y direction are formed on the liquid-crystal-side surface of the transparent substrate SUB1.

Each of these gate signal lines GL is made of, for example, a two-layer structure which includes an ITO (indium-Tin-Oxide) film as its lower layer and a molybdenum (MO) film as its upper layer.

The gate signal lines GL, together with the drain signal lines DL which will be described later, surround the rectangular area, and this rectangular area is constructed as a pixel area.

A portion of each of the gate signal lines GL has an extended portion which projects into the pixel area, and this extended portion has the function of the gate electrode of the thin film transistor TFT which will be described later.

A counter electrode CT made of an ITO film is formed in a large part of the pixel area except the periphery thereof, and a counter voltage signal line CL which runs through approximately the middle of the counter electrode CT approximately in parallel with the above-described gate signal lines GL is formed to be superposed on the upper surface of the counter electrode CT. This counter voltage signal line CL is made of, for example, a molybdenum film.

For example in this embodiment, the gate signal lines GL, the counter electrodes CT and the counter voltage signal lines CL are formed by applying patterning based on a selective etching method using a photolithographic technique to the sequentially stacked structure of an ITO film and a molybdenum film that is formed on the upper surface of the transparent substrate SUB1.

On the upper surface of the transparent substrate SUB1 formed in the above-described manner, and insulating film GI which is made of, for example, SiN is formed to a thickness of 100 nm to 4 [symbol] m in such a manner as to cover the gate signal lines GL, the counter electrodes CT and the counter voltage signal lines CL.

This insulating film GI has the function of an interlayer insulating film between the gate signal lines GL as well as the counter voltage signal lines CL and the drain signal lines DL which will be described later, the function of gate insulating films for the thin film transistors TFT which will be described later, and the function of dielectric films for the capacitance elements Cstg which will be described later.

A semiconductor layer AS made of, for example, amorphous Si (a-Si) is formed on the upper surface of the insulating film GI in such a manner as to traverse the extended portion of each of the gate signal lines GL that projects into the pixel area.

This semiconductor layer AS constitutes the semiconductor layer of the thin film transistor TFT, and a drain electrode SD1 and a source electrode SD2 are formed on the upper surface of the semiconductor layer AS, whereby a reversed staggered structure MIS transistor is formed which uses the extended portion of the gate signal line GL as its gate electrode.

Incidentally, this semiconductor layer AS is formed not only in the region in which the thin film transistor TFT is formed, but is formed to be integrally extended into the region in which the drain signal line DL to be described later is formed. This construction is intended to strengthen the interlayer insulation of the drain signal line DL from the gate signal line GL and the like.

The drain electrode SD1 and the source electrode SD2 on the semiconductor layer AS are formed at the same time as the formation of the drain signal line DL.

Specifically, the drain signal lines DL which are disposed to be extended in the y direction and to be juxtaposed in the x direction as viewed in FIG. 1 are formed on the upper surface of the insulating film GI (the semiconductor layer AS underlies the drain signal lines DL), and a part of each of the drain signal lines DL is formed to be extended on to the upper surface of the semiconductor layer AS of the thin film transistor TFT and forms the drain electrode SD1.

The drain electrode SD2 is formed to be spaced apart from the drain electrode SD1 by a gap corresponding to the channel length of the tin film transistor TFT.

This source electrode SD2 is formed to be extended into the pixel area from above the semiconductor layer AS of the thin film transistor TFT, and this extended portion is formed as a part for connection to the pixel electrode PX which will be described later.

The drain signal lines DL, the drain electrodes SD1 and the source electrodes SD2 are formed of, for example, molybdenum (Mo).

Incidentally, a high-concentration layer dₒ doped with an impurity is formed at the interface between a surface of the semiconductor layer AS and each of the source electrode SD2 and the drain electrode SD1 (refer to FIG. 4). This high-concentration layer dₒ functions as a contact layer of the thin film transistor TFT.

In addition, the high-concentration layer dₒ is formed at the interface between the drain signal lines DL and the underlying semiconductor layer AS (refer to FIG. 1).

The pixel electrode PX made of, for example, an ITO film is formed in the central portion of the pixel area on the insulating film GI except the periphery thereof (that includes the area in which the thin film transistor TFT is formed).

For example in this embodiment, this pixel electrode PX is formed by plural stripe-shaped electrodes which are extended in the y direction and juxtaposed in the x direction in the state of being superposed on the counter electrode CT, and one end of each of the stripe-shaped electrodes is connected in common to ends of the others, thereby forming a so-called comb-teeth-like pattern.

The common connection portion is extended to be superposed on the source electrode SD2 of the thin film transistor TFT, thereby providing electrical connection therebetween.

A protection film PSV which is made of, for example, SiN is formed on the surface of the transparent substrate SUB1 formed in the above-described manner. This protective film PSV is provided for preventing the thin film transistor TFT from coming into direct contact with the liquid crystal.

An alignment film ORI which covers the entire area of the display part AR is formed on the surface of the protective film PSV (refer to FIG. 1), and serves to determine the initial alignment of a liquid crystal LC which is in direct contact with the alignment film ORI.

As shown in FIG. 4, the black matrix BM is formed on the liquid-crystal-LC-side surface of the transparent substrate SUB2 in such a manner as to separate each of the pixel areas from adjacent other pixel areas. Color filters FIL for colors corresponding to individual pixels are respectively formed in apertures which are respectively formed in pixel-area portions of the black matrix BM.

Another alignment film ORI which covers the entire area of the display part AR is formed on the surface of the transparent substrate SUB2 formed in the above-described manner, and serves to determine the initial alignment direction of the liquid crystal LC which is in direct contact with the alignment film ORI.

Incidentally, in the above-described liquid crystal display device according to the embodiment of the invention, the pixel electrode PX is formed as the electrodes extended in the y direction and juxtaposed in the x direction, but they may, of course, be formed as electrodes extended in the x direction and juxtaposed in the y direction.

In addition, in this case, each of the pixel electrodes PX may be formed in a zigzag shape along its longitudinal direction so that areas having different electric field directions can be formed in one pixel area. This construction is called a multi domain scheme in which color tone can be prevented from varying when the display area AR is viewed in different directions.

In addition, in the above-described liquid crystal display device, the underlying ITO film is formed into the counter electrode CT and the overlying ITO film is formed into the pixel electrode PX, but it goes without saying that the underlying ITO film is formed into the pixel electrode PX and the overlying ITO film is formed into the counter electrode CT.

In addition, the comb-teeth-like pixel electrode PX (or the counter electrode CT) formed as an overlying layer is not limited to the ITO film, and may, of course, be formed of an opaque material such as a metal layer.

Furthermore, although the ITO film is used as a transparent material, it goes without saying that, for example, an IZO (Indium-Zinc-Oxide) film may be used.

Liquid Crystal

The liquid crystal LC has a positive or negative dielectric anisotropy and a resistivity of, for example, 1.0×10¹⁰ Ω·cm or more and 5.0×10¹³ Ω·cm or less.

The liquid crystal LC contains liquid crystal molecules each of which has, for example, a difluorobenzene structure in itself.

In this case, the liquid crystal LC may also contain liquid crystal molecules each of which has a dicyanobenzene structure in itself.

In addition, the liquid crystal LC may also contain liquid crystal molecules each of which has a difluorobenzene structure in itself, as well as liquid crystal molecules each of which has a dicyanobenzene structure in itself.

In addition, the liquid crystal LC may also contain liquid crystal molecules each of which has a monocyanocyclohexane structure in itself.

In addition, the liquid crystal LC may also contain liquid crystal molecules each of which has a monocyanocyclohexane structure in itself, as well as liquid crystal molecules each of which has a difluorobenzene structure in itself.

It has been confirmed that the liquid crystal LC having such a composition allows its ionic impurities to be absorbed into the alignment films ORI (which will be described later) in relation to the alignment films ORI to such an extent that a display defect due to image retention can be fully solved.

Alignment Film

Each of the alignment films ORI is formed to a thickness of 40 nm to 300 nm, and at least the alignment film ORI formed on the transparent substrate SUB1 is made of a material having uniaxial orientation properties and contains a diamine structure which traps ionic impurities.

The reason why the material having uniaxial orientation properties is used is that such material is highly effective in preventing so-called Ac image retention. From this fact, it is apparent that the material need not necessarily have uniaxial orientation properties for the purpose of achieving only the theme of the invention which solves image retention due to ionic impurities.

It has also been confirmed that such alignment film that contains the above-described diamine structure has the nature of absorbing (trapping) ionic impurities, thereby greatly restraining the occurrence of image retention due to the ionic impurities.

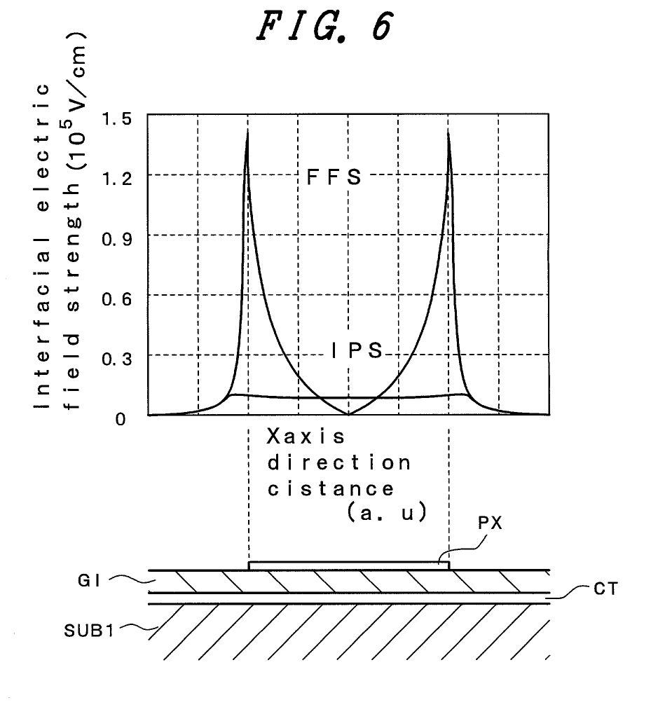

In the liquid crystal display device having the above-described construction, as shown in FIG. 6, the electric field strengths at the fringes of, for example, the comb-teeth like pixel electrode PX are strong, and in these portions, drifts of ionic impurities easily occur. However, since the ionic impurities can be fully absorbed by the alignment film ORI, it is possible to restrain the occurrence of the image retention due to the ionic impurities.

The above-described diamine structure is expressed by the following chemical formula (1) or (2):

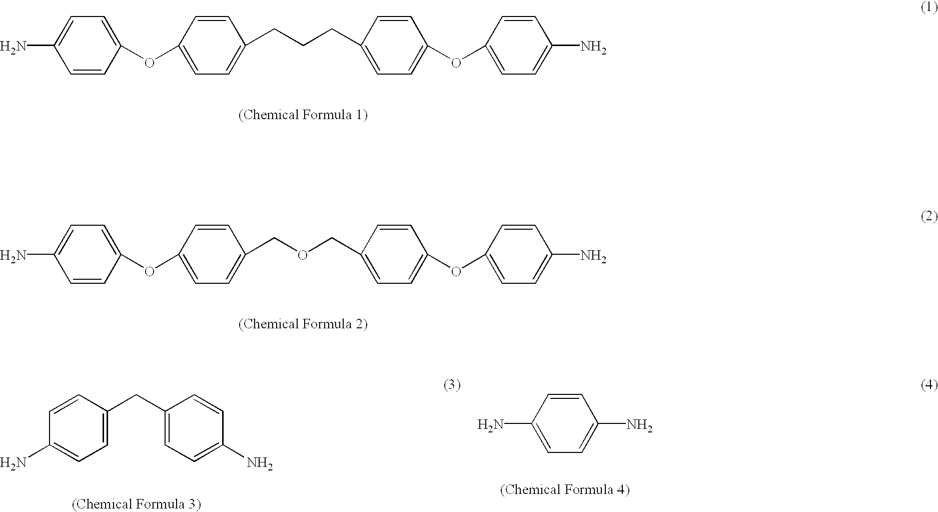

Materials having these diamine structures can also be used in mixed form, and in the case of the mixture of the material(s) expressed by the chemical formula (1) and/or the chemical formula (2) and the material(s) expressed by the chemical formula (3) and/or the chemical formula (4), good results can be obtained by making the proportion of the former material(s) 30 to 70%.

By using such alignment film ORI, it is possible to achieve the advantages that the AC image retention becomes 8% or less and that ionic image retention is not observed after pixels have been turned on for two minutes.

In this case, if the ionic image retention is observed by using a Pritchard-made luminance meter PR-900, it can be confirmed that the ionic image retention strength becomes 3 or less or 2 or less.

It goes without saying that the alignment film ORI having such a construction can be similarly formed on the transparent substrate SUB2.

As is apparent from the foregoing description, in the liquid crystal display device according to the invention, it is possible to restrain the occurrence of ionic image retention.

What is claimed is:

1. A liquid crystal display device comprising:
substrates disposed in opposition to each other with a liquid crystal being interposed therebetween;
a pixel electrode formed in each pixel area on a liquid-crystal-side surface of one of the substrates;
a counter electrode which generates an electric field between itself and the pixel electrode; and
alignment films disposed in contact with the liquid crystal on the liquid-crystal-side surfaces of the respective substrates,
the liquid crystal having a positive or negative dielectric anisotropy,
each of the alignment films being made of a material containing a diamine structure which traps ionic impurities.

2. A liquid crystal display device according to claim 1, wherein each of the alignment films has uniaxial orientation properties.

3. A liquid crystal display device according to claim 1 or 2, wherein the pixel electrode and the counter electrode are formed as different layers with an insulating film interposed therebetween, either one of the pixel electrode and the counter electrode being formed of a transparent conductive layer.

4. A liquid crystal display device according to claim 3, wherein the transparent conductive layer is made of Indium-Tin-Oxide (ITO).

5. A liquid crystal display device according to claim 3, wherein the transparent conductive layer is made of Indium-Zinc-Oxide (IZO).

6. A liquid crystal display device according to claim 1, wherein the diamine structure is expressed by the following chemical formula (1):

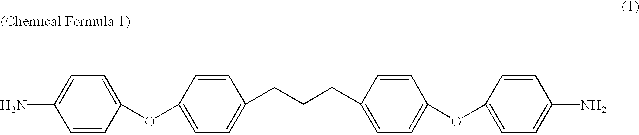

7. A liquid crystal display device according to claim 1, wherein the diamine structure is expressed by the following chemical formula (2):

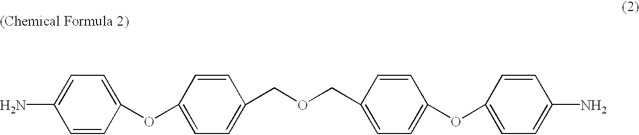

8. A liquid crystal display device according to claim 1, wherein the diamine structure is expressed by the following chemical formula (3):

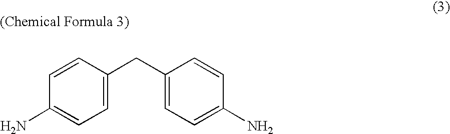

9. A liquid crystal display device according to claim 1, wherein the diamine structure is expressed by the following chemical formula (4):

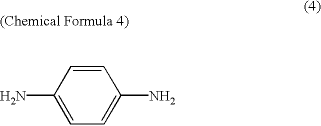

10. A liquid crystal display device according to claim 3, wherein the one of the pixel electrode and the counter electrode that is formed of the transparent conductive layer is formed in a layer underlying the insulating film, while the other is formed in a layer overlying the insulating film and includes electrodes disposed to be superposed on the one electrode and to be extended in one direction and juxtaposed in a direction transverse to the one direction.

11. A liquid crystal display device according to claim 10, wherein AC image retention is 8% or less.

12. A liquid crystal display device according to any of claims 1 to 11, wherein ionic image retention is not observed after pixels have been turned on for two minutes.

13. A liquid crystal display device according to claim 1, wherein the liquid crystal has a resistivity of 1.0×10¹⁰ Ω·cm or more and 5.0×10¹³ Ω·cm or less.

14. A liquid crystal display device according to claim 1 or 2, wherein each of the alignment films has a film thickness of 40 nm to 300 nm.

15. A liquid crystal display device according to any of claim 1, 3 and 10, wherein the insulating film has a film thickness of 100 nm to 4 [symbol] m.

16. A liquid crystal display device according to claim 1 or 13, wherein the liquid crystal contains liquid crystal molecules each of which has a difluorobenzene structure in itself.

17. A liquid crystal display device according to claim 1 or 13, wherein the liquid crystal contains liquid crystal molecules each of which has a dicyanobenzene structure in itself.

18. A liquid crystal display device according to claim 1 or 13, wherein the liquid crystal contains liquid crystal molecules each of which has a difluorobenzene structure in itself, as well as liquid crystal molecules each of which has a dicyanobenzene structure in itself.

19. A liquid crystal display device according to claim 1 or 13, wherein the liquid crystal contains liquid crystal molecules each of which has a monocyanocyclohexane structure in itself.

20. A liquid crystal display device according to claim 1 or 13, wherein the liquid crystal contains liquid crystal molecules each of which has a monocyanocyclohexane structure in itself, as well as liquid crystal molecules each of which has a difluorobenzene structure in itself.

21. A liquid crystal display device according to any of claims 1 to 20, wherein its ionic image retention strength is 3 or less.
